(19) United States
(12) Patent Application Publication
(10) Pub. No.: US 2020/0378076 A1
(43) Pub. Date: Dec. 3, 2020

(54) Contrast Surface Marking Devices and Systems

(71) Applicant: Driskell Holdings, LLC, Jacksonville, FL (US)

(72) Inventors: Gregory W. Driskell, St Johns, FL (US); Michael D. Green, Atlantic Beach, FL (US)

(21) Appl. No.: 16/888,769

(22) Filed: May 31, 2020

Related U.S. Application Data
(60) Provisional application No. 62/856,035, filed on Jun. 1, 2019.

(51) Int. Cl. E01F 9/524; E01F 9/576; G02B 5/136

(52) U.S. Cl. CPC E01F 9/524; B60W 60/0015; G02B 5/136; E01F 9/576

(57) ABSTRACT

What is needed is an apparatus and system for creating high contrast to heighten marking conspicuousness and heighten driver safety under extreme light conditions. According to the present disclosure, a ridged contrast surface marking may comprise a topography that may allow for consistently visible and conspicuous messaging of proximate base surface markings, which may limit loss of visibility or conspicuity during extreme light conditions. In some aspects, ridged contrast surface markings may be used in conjunction with more traditional contrasting and color techniques, such as with painting, coating, or tape. Ridged contrast surface markings may provide surrounding contrast to flat messaging or other profiled solutions, wherein even if light reflection in extreme light conditions may reduce visibility of the message, sufficient surrounding contrast would still allow for comprehension of the message.

### CROSS-REFERENCE TO RELATED APPLICATION

This application claims priority to and the full benefit of U.S. Provisional Patent Application Ser. No. 62/856,035, filed Jun. 1, 2019, and titled “CONTRAST SURFACE MARKING DEVICES AND SYSTEMS”, the entire contents of which are incorporated in this application by reference.

### BACKGROUND OF THE DISCLOSURE

Visual perception, or the sense of sight, refers to the ability to interpret a surrounding environment through light within a visible spectrum. This visible spectrum refers to the range of the electromagnetic spectrum that is visible to the human eye, also known as visible light. The visible spectrum is created by light reflected by objects in the environment. Isaac Newton was one of the earliest scientists who observed that when light hits a glass prism, some of the light is reflected while some of the light passes into and through glass, becoming different colored bands. As some different colors of light move at different speeds, certain colors would be bent or refracted as it passed through a prism, such as the color red. Thomas Young and Hermann von Helmholtz theorized that the human eye uses three different light receptors to perceive color.

A visual system, part of the central nervous system, gives the mechanical and neural ability to process visual detail as sight. The visual system detects information from visible light to effectively build out a representation of the surrounding environment. The visual system is responsible for receiving light, forming representations of the environment, creating perception from two-dimensional projects, categorizing visual objects, and assessing distances between and to other objects. This is in contrast with visual perception, the psychological sorting of visual information.

The sun is one of the most important natural sources of light that helps people see throughout the day. Road markings and signs use the light from the sun to enhance the visibility of their signals or messages, which is greatly diminished at night. Sunrise, sunset, dusk, dawn, weather, and low light conditions are dangerous times for a driver since a driver's view and vision are naturally compromised. Low light or limited visibility conditions make it harder for a driver's eyes to adjust to a low light roadway, making it difficult to see pedestrians, markings, or other vehicles. Though a driver can take some steps to enhance their ability to perceive the road, such as by making sure their headlights are clean or keeping their windshield clean, these are internal solutions to an external problem.

As a driver's eyes adjust to changing light conditions, their peripheral vision, color contrast perception, and depth perception shift accordingly. However, drivers need as much help as possible as they make that visual adjustment or, in cases of extreme light conditions, travel through those conditions as best they can while still driving safely and not endangering others. In these conditions, headlight angles or extreme light conditions, such as sunset or sunrise, can make certain road markings seem to disappear or become inconspicuous to the human eye. If a driver loses visibility in markings, they may lose context for navigating the road.

For self-driving cars, which rely on markings to navigate, these conditions may change the contours of what constitutes an open road or the relevant travel lane. Loss of contrast for the markings create navigation issues for cars or vehicles with autonomous drive control. In some extreme circumstances, the vehicles may lose the context and boundaries of the road or travel lane, losing the ability to safely and accurately navigate the roadway.

### SUMMARY OF THE DISCLOSURE

What is needed is an apparatus and system for creating high contrast to heighten marking conspicuousness and heighten driver safety under extreme light conditions. Further, where autonomous vehicles may be navigating through traffic or crowds of people, there needs to be a safe and reliable system of roadway markings that maintain visibility and conspicuity in any conditions.

According to the present disclosure, a ridged contrast surface marking with a raised and angular profile may provide consistently visible and conspicuous messaging, contrast to messaging, or both, which may limit loss of visibility or conspicuity during extreme light conditions. In some aspects, ridged contrast surface markings may be used in conjunction with more traditional contrasting and color techniques, such as with painting, coating, or tape. Ridged contrast surface markings may provide surrounding contrast to messaging of both flat and profiled markings, wherein even if light reflection in extreme light conditions may reduce visibility of the message, sufficient surrounding contrast would still allow for comprehension of the message.

The present disclosure relates to a ridged contrast surface marking comprising a profile layer comprising an angular profile installable parallel to a base surface and proximate to a base surface marking with messaging, wherein the angular profile comprises a topography of angles that reflect light out of a direction of a person or object traversing the base surface, that absorb light and limit reflection of light into the direction of the person or object, or both, and wherein the proximity of the profile layer to the base surface marking allows for increased or maintained visibility and conspicuity of the messaging when traversing the base surface in extreme light conditions. In some aspects, the system may further comprise a base surface traversable by one or more person or object and a base surface marking on the base surface, wherein the base surface marking provides messaging.

In some embodiments, the profile layer may comprise one or both a reflective material or reflective coating that may increase visibility of the base surface marking. In some implementations, the profile layer comprises one or both a light absorbing material or light absorbing coating increasing visibility and conspicuity of the base surface marking. In some aspects, the angular profile may comprise a symmetrical profile. In some embodiments, the angular profile may comprise an asymmetrical profile.

In some aspects, the angular profile may be configured to increase visibility and conspicuity of the messaging for one or both autonomous vehicles and vehicles with automated driver assistance systems traversing the base surface. In some embodiments, the ridged contrast surface marking may further comprise a conformance layer installable parallel to the base surface and below the profile layer, wherein the conformance layer conforms the ridged contrast surface marking to regulatory standards. In some implementations, the angular profile may be pressed onto the base surface prior to solidification of the base surface. In some embodiments, the ridged contrast surface marking is installed through adhesion. In some aspects, the ridged contrast surface marking may further comprise an adhesive layer located under the profile layer, wherein the adhesive layer attaches the ridged contrast surface marking to the base surface.

### BRIEF DESCRIPTION OF THE DRAWINGS

The accompanying drawings, that are incorporated in and constitute a part of this specification illustrate several embodiments of the disclosure and, together with the description, serve to explain the principles of the disclosure:

FIG. 1A illustrates a cross section of an exemplary ridged contrast surface marking, according to some embodiments of the present disclosure.

FIG. 1B illustrates a cross section of an exemplary ridged contrast surface marking, according to some embodiments of the present disclosure.

FIG. 2A illustrates a cross section of an exemplary ridged contrast surface marking, according to some embodiments of the present disclosure.

FIG. 2B illustrates a cross section of an exemplary ridged contrast surface marking, according to some embodiments of the present disclosure.

FIG. 3 illustrates a cross section of an exemplary ridged contrast surface marking with a range of light source positions, according to some embodiments of the present disclosure.

FIG. 4 illustrates a cross section of an exemplary ridged contrast surface marking with a range of light source positions, according to some embodiments of the present disclosure.

FIG. 5A illustrates an exemplary ridged contrast surface marking, according to some embodiments of the present disclosure.

FIG. 5B illustrates an exemplary ridged contrast surface marking, according to some embodiments of the present disclosure.

FIG. 6A illustrates an exemplary ridged contrast surface marking, according to some embodiments of the present disclosure.

FIG. 6B illustrates an exemplary ridged contrast surface marking, according to some embodiments of the present disclosure.

FIG. 7 illustrates a roadway with exemplary ridged contrast surface markings, according to some embodiments of the present disclosure.

FIG. 8 illustrates exemplary ridged contrast surface markings, according to some embodiments of the present disclosure.

FIG. 9A illustrates a cross section of exemplary ridged contrast surface markings, wherein the ridged contrast surface markings may be installable on the surface of a base surface.

FIG. 9B illustrates a cross section of exemplary ridged contrast surface markings, wherein the ridged contrast surface markings may be installable on the surface of a base surface.

FIG. 9C illustrates a cross section of exemplary ridged contrast surface markings, wherein the ridged contrast surface markings may be installable on the surface of a base surface.

FIG. 9D illustrates a cross section of exemplary ridged contrast surface markings, wherein the ridged contrast surface markings may be installable on the surface of a base surface.

FIG. 10A illustrates cross sections of exemplary ridged contrast surface markings, wherein the ridged contrast surface markings may be installable into the surface of a base surface.

FIG. 10B illustrates cross sections of exemplary ridged contrast surface markings, wherein the ridged contrast surface markings may be installable into the surface of a base surface.

FIG. 10C illustrates cross sections of exemplary ridged contrast surface markings, wherein the ridged contrast surface markings may be installable into the surface of a base surface.

FIG. 10D illustrates cross sections of exemplary ridged contrast surface markings, wherein the ridged contrast surface markings may be installable into the surface of a base surface.

FIG. 11A illustrates an exemplary vertical sign with ridged contrast surface markings, according to some embodiments of the present disclosure.

FIG. 11B illustrates an exemplary vertical sign with ridged contrast surface markings, according to some embodiments of the present disclosure.

FIG. 12 illustrates an exemplary street with roadway ridged contrast surface markings and sign ridged contrast surface marking, according to some embodiments of the present disclosure.

FIG. 13A illustrates an exemplary mold system for manufacturing ridged contrast surface markings, according to some embodiments of the present disclosure.

FIG. 13B illustrates an exemplary ridged contrast surface marking, wherein the ridged contrast surface marking may be manufactured from a mold system.

FIG. 13C illustrates an exemplary ridged contrast surface marking, wherein the ridged contrast surface marking may be manufactured from a mold system.

FIG. 14 illustrates an exemplary calendaring system, wherein the calendaring system may be used to manufacture ridged contrast surface markings.

FIG. 15 illustrates an exemplary roller, wherein the roller may be used directly on a base surface to create ridged contrast surface markings.

### DETAILED DESCRIPTION

The present disclosure provides generally for an improved marking system. More specifically, the present disclosure relates to ridged contrast surface markings that may provide contrast messaging.

In the following sections, detailed descriptions of examples and methods of the disclosure will be given. The description of both preferred and alternative examples, though thorough, are exemplary only, and it is understood to those skilled in the art that variations, modifications, and alterations may be apparent. It is therefore to be understood that the examples do not limit the broadness of the aspects of the underlying disclosure as defined by the claims.

### Glossary

Extreme Light Conditions: as used herein refers to environmental, proximate, ambient, or any condition that may cause extreme angles of light to hit the base surface. In some aspects, extreme light conditions may be caused by sun light, such as at dawn or dusk. In some embodiments, extreme light conditions may be induced by ambient conditions, such as surrounding reflective surfaces, including snow drifts or puddles, as non-limiting examples. In some aspects, extreme light conditions may be caused by man-made light sources such as headlights, flood lights, construction lighting, and emergency lighting, as non-limiting examples. In some implementations, the extreme light conditions may be exacerbated by environmental conditions, such as rain, fog, or other conditions that may affect light reflection or refraction. In some aspects, extreme light conditions may occur or may be exacerbated by different levels within roadways, such as rutting, surface undulations, speed bumps, bridges, potholes, and hills.
User: as used herein refers to an individual who may interact with ridged contrast surface markings. In some embodiments, a user may comprise a pedestrian, cyclist, motorist, or passenger, as non-limiting examples.
Ridged Contrast Surface Markings: as used herein refers to a surface marking system or device with an angular profile, wherein a topography of the angular profile limits loss of visibility or conspicuity of the roadway guidance in extreme light conditions. In some aspects, a ridged contrast surface marking may be installed proximate to a base surface marking, wherein the proximity increases visibility and conspicuity of the base surface marking and its messaging. In some embodiments, ridged contrast surface markings may surround a base surface marking. In some implementations, ridged contrast surface markings may be installed in parallel for at least a portion of the base surface marking, such as a lane line. Surrounding ridged contrast surface markings may be preferable where the base surface marking may comprise a small shape or short strip, and parallel installation may be preferable for extensive base surface markings.
Base Surface: as used herein refers to a traversable surface wherein ridged contrast surface markings may be installed horizontally on the base surface, such as integrated parallel with the base surface, or perpendicular to the base, such as integrated in a structure extending from a base surface. For example, a road sign may extend vertically from the base surface, and ridged contrast surface markings on the sign may be flush with the sign and perpendicular to the base surface.
Base Surface Marking: as used herein refers to a surface marking that provides a message to users traversing the base surface. In some aspects, a base surface marking may comprise a traditional flat marking, such as through application of a paint, coating, or other flat material. In some embodiments, the base surface marking may comprise a raised or partially raised marking, such as tactile paving, rumble strips, speed bumps, profiled or textured pavement markings, wet visibility patterns, or reflective studs, as non-limiting examples. In some implementations, the base surface marking may comprise a combination of flat markings and raised markings, such as a traditional lane line with periodic reflective studs.
Message or Messaging: as used herein refers to informational indication provided by or enhanced by ridged contrast surface markings. In some embodiments, a message may comprise one or more pattern, symbol, text, or color, as non-limiting examples. In some aspects, a message may comprise lane indications, such as single or double line. In some implementations, a message may comprise warnings or instructions, such as “wrong way,” “merge,” directional arrows, or “stop.”
Profile Layer: as used herein refers to an upper layer of ridged contrast surface markings, which may comprise a topography that may allow for visibility and conspicuity of the ridged contrast surface marking, particularly in extreme light conditions. In some aspects, a profile layer may comprise a plurality of profiles, wherein each profile may provide a contrast message, such as through use different colors or angles of extension. In some embodiments, a profile layer may be symmetrical, wherein both the colors and angles may be constant.

When light hits an object, it reflects in the opposite direction by the same angle. This is referred to a specular reflection. When there is extreme light such as high beam headlights of an oncoming vehicle during night or the sun shining from a low horizon during day, the sources intense light strikes the surface of the road and its marking at a low entrance angle. This intense light then reflects in the opposite direction at the same low angle, often directly into the vehicle's cameras or motorists' eyesight approaching from the opposite direction. The specular reflection of this intense light overpowers the color and common texture contrasts between the marking and the surrounding surface. Causing the markings to seemingly disappear to both a motorist and a vehicles camera system.

Diffuse reflection is that of which rays of light may reflect in multiple different angles from the surface. This may occur when a beam of light is not necessarily in the view of the motorist or Automated Driver Assistance System but instead is reflected at more than one angle which may impair the vision of the motorist or the vehicles cameras. This may cause the same phenomenon as specular reflection.

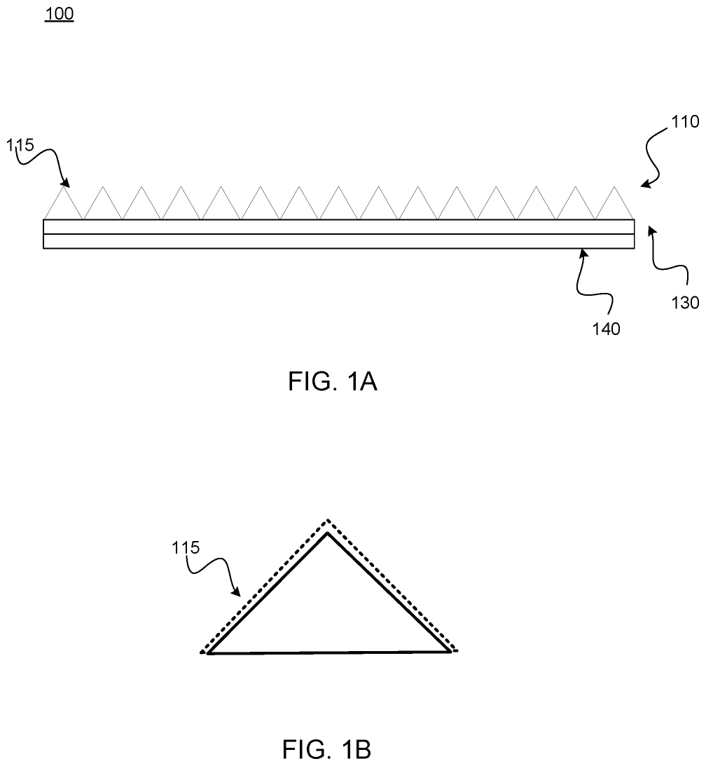

Referring now to FIGS. 1A-1B, a cross section of an exemplary ridged contrast surface marking 100 is illustrated, wherein the angular profile may be symmetrical. In some aspects, a ridged contrast surface marking 100 may comprise a profile layer 110 as an upper layer, wherein the profile layer 110 may comprise an angular profile 115 of two or more angles. During extreme light conditions, intense light may strike the ridged contrast surface marking 100 at a low entrance angle, and the angles of the profile layer 110 may cause the light to reflect back toward its source or out of the direction of the oncoming vehicle. The angles of the profile layer 110 may thwart the light's effect on the contrast of the marking, keeping it visible for both human and machine driving systems.

The reflection of light may also be different based on the surface of the road; the texture of the asphalt often varies due to size and type of aggregate used and may cause light to reflect in different directions, as referred to above. Different levels within roadways may also have an effect, such as rutting, surface undulations, speed bumps, bridges, potholes, and hills as non-limiting examples. Sudden or even anticipated bumps and jarring from the road are already distracting and may heighten the danger associated with loss of visibility of conspicuity of messages.

Vehicles equipped with automated driver assistance systems (“ADAS”), such as active and passive lane departure systems rely heavily on their ability to distinguish the markings from the roadway surface. Further, the pursuit of wide use of Connected and Autonomous Vehicles (“CAV”) creates an even greater need to ensure that the roadway markings are visible and conspicuous to both human and machine drivers.

In some embodiments, the angled ridges 115 may be coated in a paint or material that may enhance the contrasting abilities of the ridged contrast surface marking 100. In some aspects, the coating may provide a matte finish, which may reduce glare, such as may occur when a surface is wet, icy, slick, or proximate to other shiny surfaces. In some aspects, the profile layer 110 may be coated with a paint or material that may enhance one or more characteristics of the ridged contrast surface marking 100, such as visibility or durability, as non-limiting examples. In some embodiments, the ridged contrast surface marking may be used as the entire marking or as an enhancement to other marking materials.

For example, the profile layer 110 may be coated with a retroreflective material, which may enhance visibility of the profile layer 110 where the base surface may be traversed by vehicles or users with portable lighting. For example, the base coating may comprise a pigment, and a top coat may comprise glass micro-spheres. In some embodiments, the profile layer 110 may comprise a flexible material, such as a polymeric, rubber, epoxy, or acrylic, as non-limiting examples. In some implementations, at least a portion of the profile layer 110 may comprise a rigid material, such as a cement, asphalt, glass, or other rigid material.

In some implementations, ridged contrast surface markings 100 may comprise a plurality of layers. In some embodiments, the ridged contrast surface markings 100 may comprise a conformance layer 130 and an adhesive layer 140. In some implementations, the conformance layer 130 may conform the ridged contrast surface marking to regulatory standards, such as durability, materials, and size requirements. In some aspects, the adhesive layer 140 may allow for installation of the ridged contrast surface markings 100 into a base surface. For example, the ridged contrast surface markings 100 may be attached through adhesive bonding, thermal bonding, or mechanically fastened, as non-limiting examples. In some embodiments, the method of installation may depend on the base surface, such as a concrete walkway, an asphalt roadway, or interior flooring, as non-limiting examples.

In some embodiments, ridged contrast surface markings 100 may be manufactured through one or more manufacturing techniques, such as compression, calendaring, extrusion, injection, transfer, or 3D printing, as non-limiting examples. In some implementations, the method of manufacture may depend on the application, such as the type of base surface, as installing ridged contrast surface markings 100 on an asphalt roadway may have different requirements than on an interior pedestrian walkway.

In some aspects, the angles and height of the angled ridges 115 may depend on the use. For example, where the base surface may comprise a roadway, the height may need to be low enough as to not impede the ability to drive over the base surface, and the angle may need to be perceptible to drivers and passengers. As another example, where the base surface may comprise a shared path for both autonomous vehicles and pedestrians, the height may need to be low enough as to not cause pedestrians to trip or stumble, and the angle may need to be perceptible to both autonomous vehicles and pedestrians of various sizes, including those who may be in a wheelchair.

As an illustrative example, the ridged contrast surface markings 100 may be installed on a roadway, wherein users may traverse the base surface in a vehicle. Drivers and passengers may be able to view acute profiles that may face the direction of travel. The proximity of the ridged contrast surface markings 100 to base surface markings on the base surface may cause sufficient contrast to allow for one or both increased or maintained visibility and conspicuity of the base surface marking.

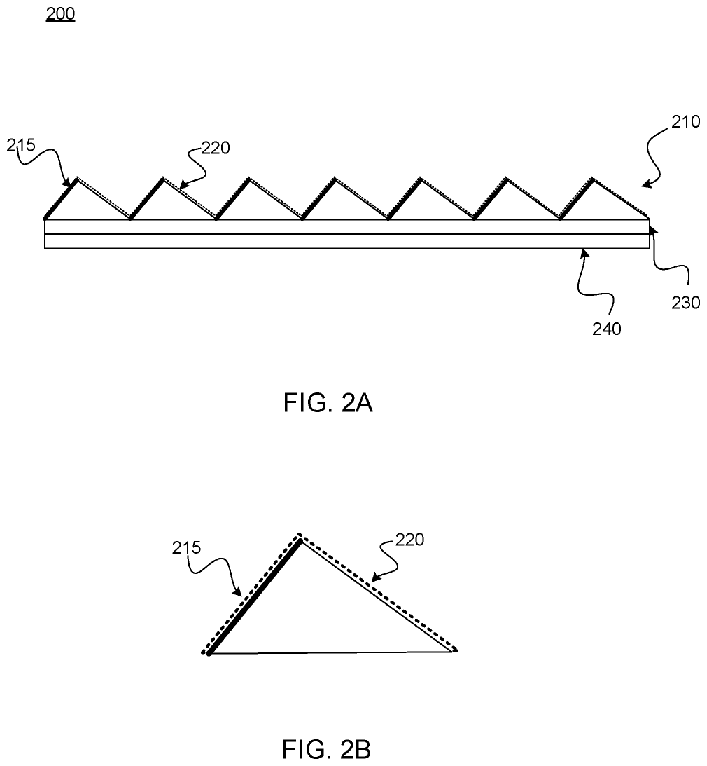

Referring now to FIGS. 2A-2B, a cross section of an exemplary ridged contrast surface marking 200 is illustrated, wherein the angular profile may be asymmetrical. In some aspects, a ridged contrast surface marking 200 may comprise a profile layer 210 as an upper layer, wherein the profile layer 210 may comprise a first profile 215 and a second profile 220. In some embodiments, the first profile 215 may be coated in a paint or material, wherein the coating may be visible when a user is traversing a base surface in a first direction. In some aspects, the second profile 220 may be coated in a paint or material, wherein the coating may be visible when a user is traversing a base surface in a second direction. In some implementations, the first direction may be the opposite direction of the second direction.

In some aspects, the profile layer 210 may be coated with a paint or material that may enhance one or more characteristics of the ridged contrast surface marking 200, such as visibility or durability, as non-limiting examples. For example, the profile layer 210 may be coated with a retroreflective material, which may enhance visibility of the profile layer 210 where the base surface may be traversed by vehicles or users with portable lighting. For example, the base coating may comprise a pigment, and a top coat may comprise glass micro-spheres. In some embodiments, the profile layer 210 may comprise a flexible material, such as a polymeric, rubber, epoxy, or acrylic, as non-limiting examples. In some implementations, at least a portion of the profile layer 210 may comprise a rigid material, such as a cement, asphalt, glass, or other rigid material.

In some implementations, ridged contrast surface markings 200 may comprise a plurality of layers. In some embodiments, the ridged contrast surface markings 200 may comprise a conformance layer 230 and an adhesive layer 240. In some implementations, the conformance layer 230 may conform the ridged contrast surface marking to regulatory standards. In some aspects, the adhesive layer 240 may allow for installation of the ridged contrast surface markings 200 into a base surface. For example, the ridged contrast surface markings 200 may be attached through adhesive bonding, thermal bonding, or mechanically fastened, as non-limiting examples. In some embodiments, the method of installation may depend on the base surface, such as a concrete walkway, an asphalt roadway, or interior flooring, as non-limiting examples.

In some aspects, the angles and height of the first and second profile may depend on the use. For example, where the base surface may comprise a roadway, the height may need to be low enough as to not impede the ability to drive over the base surface, and the angle may need to be perceptible to drivers, passengers, and CAV. As another example, where the base surface may comprise an interior walkway, the height may need to be low enough as to not cause pedestrians to trip or stumble, and the angle need to be perceptible to pedestrians of various sizes, including those who may be in a wheelchair.

As an illustrative example, the ridged contrast surface markings 200 may be installed on a roadway, wherein users may traverse the base surface in a vehicle. Drivers and passengers may be able to view acute profiles that may face the direction of travel. For example, the first profile 215 may comprise a series of 65-degree angles, and the second profile 220 may comprise a series of 35-degree angles.

In some aspects, the profile layer 210 may be coated with a paint or material that may enhance one or more characteristics of the ridged contrast surface marking 200, such as visibility or durability, as non-limiting examples. For example, the profile layer 210 may be coated with a retroreflective material, which may enhance visibility of the profile layer 210 where the base surface may be traversed by vehicles or users with portable lighting. In some implementations, the profile layer 210 may comprise a material that may absorb light, reflect light, or both, which may increase contrast and conspicuity.

In some aspects, the surface color sets of the profile layer 210 may be the same or different for each direction. In some embodiments, the surface color sets may provide messaging and contrast. In some implementations, the first and second profiles may comprise different materials or coatings, wherein each material or coating may comprise different light absorption levels. For example, different portions of a ridged contrast surface marking 200 may absorb a different range of visible wavelengths, which may increase contrast between colors. In some aspects, the angles and height of the first and second profile may depend on the use. In some embodiments, the angle and height may be based on increasing contrast. In some implementations, light absorption may be caused and controlled by one or more material, coating, or combinations.

In some embodiments, the profile layer 210 may comprise a flexible material, such as a polymeric, rubber, epoxy, or acrylic, as non-limiting examples. In some implementations, at least a portion of the profile layer 210 may comprise a rigid material, such as a cement, asphalt, glass, or other rigid material. In some implementations, ridged contrast surface markings 200 may comprise a plurality of layers. In some embodiments, the ridged contrast surface markings 200 may comprise a conformance layer and an adhesive layer. In some aspects, one or both the conformance layer and the adhesive layer may comprise a heating mechanism, such as an active heater, a thermal material, or positive temperature coefficient material, as non-limiting examples. A heating element may limit the accumulation of ice or snow, which may reduce the effectiveness of the ridged contrast surface marking 200.

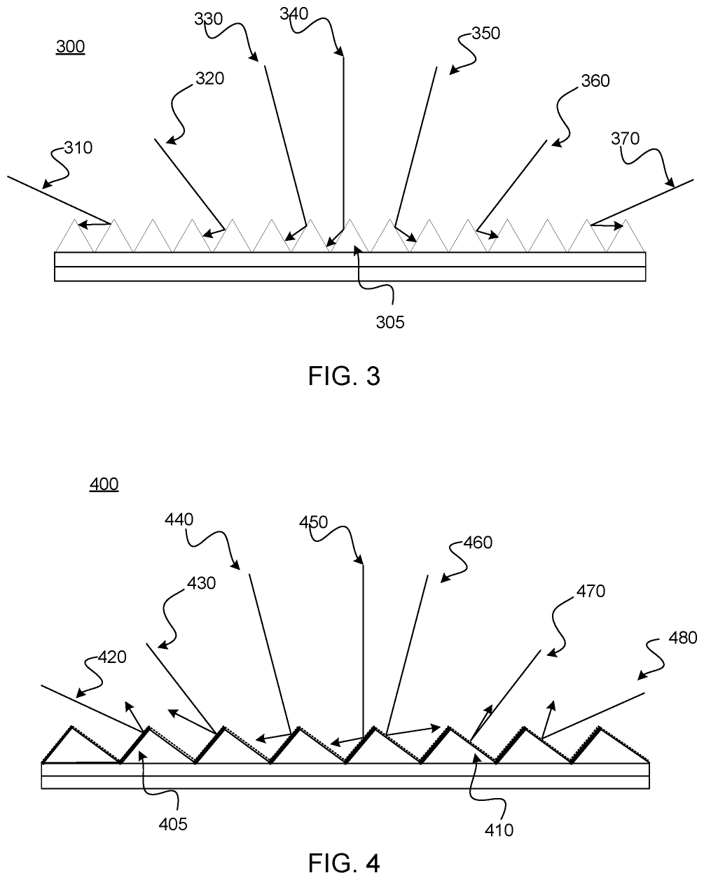

Referring now to FIG. 3, a cross section of an exemplary ridged contrast surface marking 300 with a range of light source positions is illustrated. In some aspects, the angles of incoming light that may reflect from the ridged contrast surface marking 300 may vary and change depending on the positions of light sources and intervening obstructions. In some embodiments, the angular profile of the ridged contrast surface marking may absorb light, limiting reflection of light back toward a person or vehicle traversing the base surface. In some implementations, the angular profile may provide a combination of light absorption and light reflection, drastically increasing visibility and conspicuity of a base surface marker and its messaging, such as a lane line, warning, or directional indicator.

As an illustrative example for a roadway traversable in an eastward direction, pre-noon light 310, 320, 330 may reflect off one side of the profile layer 305, noon light 340 may reflect off both sides of the profile layer 305, and post-noon light 350, 360, 370 may reflect off the other side of the profile layer 305. In contrast to a flat surface or other profiled solutions currently available, light reflecting from the profile layer 305 is unlikely to reflect back but instead may reflect in a different direction or may hit another portion of the profile layer 305, eliminating or reducing the negative effect of specular or diffuse reflection.

Referring now to FIG. 4, a cross section of an exemplary ridged contrast surface marking 400 with a range of light source positions is illustrated. In some aspects, the angles of incoming light that may reflect from the ridged contrast surface marking 400 may vary and change depending on the positions of light sources and intervening obstructions. As an illustrative example for a roadway traversable in an eastward direction, pre-noon light 420, 430, 440 may reflect off a first profile 405 of the profile layer, noon light 440 may reflect off both profiles of the profile layer 405, and post-noon light 460, 470, 480 may reflect off a second profile 410 of the profile layer 305. In contrast to a flat surface, light reflecting from the profile layer 405 is unlikely to reflect back but instead may reflect in a different direction or may hit another portion of the profile layer 405, eliminating or reducing the negative effect of specular or diffuse reflection.

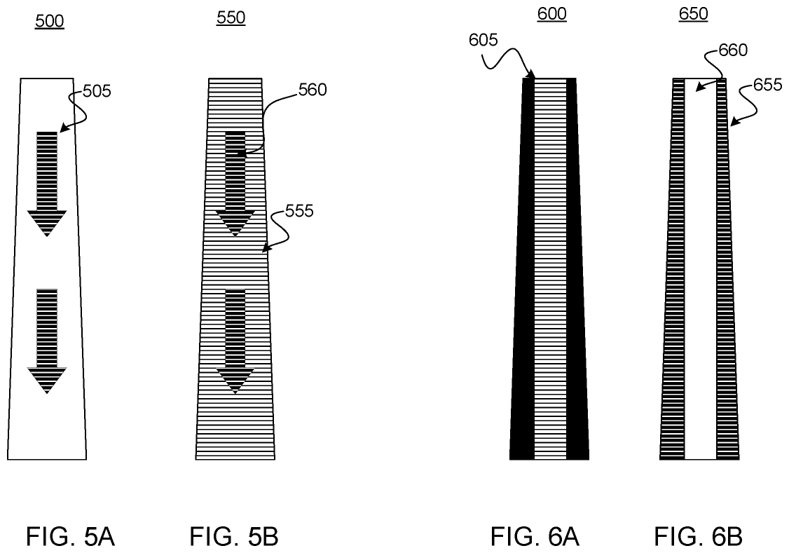

Referring now to FIGS. 5A-5B, exemplary base surface markings 500, 550 with ridged contrast surface markings 505, 555 are illustrated. In some embodiments, as illustrated in FIG. 5A, a base surface marking 500 may comprise a message of direction, wherein a ridged contrast surface marking 505 may be located in the message portion, providing contrast to the surrounding surface of the base surface marking 500. Where the base surface marking 500 may comprise a combination of colors, the contrast surface marking 505, 555 may comprise a contrasting color in conjunction with the profile layer.

In some implementations, the ridged contrast surface marking 555 may surround the comprise the message 560 of the base surface marker 550. In some aspects, the message 560 may comprise a separate raised mechanism. In some embodiments, having both the message and the surface 560 with a profile may increase or maintain the contrast between the colors in extreme light conditions. In some embodiments, the base surface markings 500, 500 may be separately installed or applied to a base surface. For example, the base surface marking 500, 550 may comprise paint, tape, or other color application that may be applied to the base surface. The profile of the message 505 may be sufficient to provide contrast during extreme light conditions.

In some implementations, the ridged contrast surface marking 555 may comprise a continuous piece or installation that may extend for the length of the base surface marking 550. In some embodiments, the ridged contrast surface marking 505 may comprise multiple pieces that may be applied or installed separately. This may depend on the length of the base surface marking 550, the location of the ridged contrast surface marking 505, and installation techniques, as non-limiting examples.

For example, a ridged contrast surface marking 555 may be rolled onto a base surface for a continuous stretch in parallel to the base surface marking 550, and another ridged contrast surface marker 505 may be periodically stamped in line with the message of the base surface marking 500. As another example, the ridged contrast surface marking 505, 555 may comprise an installable material that may be installed in panels or rolls.

Referring now to FIGS. 6A-6B, exemplary base surface markings 600, 650 with ridged contrast surface markings 605, 655 are illustrated. In some embodiments, as illustrated in FIG. 6A, a ridged contrast surface marking 605 may be located in a message portion of a base surface marking 600 with a profile that provides contrast to the surrounding portion without a profile. In some implementations, the base surface marking 600 may comprise a message that may be separately installed or applied to a base surface, wherein the base surface marking 600 may be separate from the ridged contrast surface marking 605. For example, the surface may comprise paint, tape, or other color application that may be applied to the base surface. The profile of the ridged contrast surface marking 605 on the message portion may be sufficient to provide contrast during extreme light conditions.

In some aspect, as illustrated in FIG. 6B, a base surface marking 650 may comprise a message 660 without a profile surrounded by a ridged contrast surface marking 655 with an angular profile. In some implementations, the ridged contrast surface marking 650 may comprise a continuous piece with different coloration to differentiate between the ridged contrast surface marking 655 and the surface 660. In some embodiments, the ridged contrast surface marking 655 may comprise multiple pieces that may be applied or installed separately.

In some embodiments, a ridged contrast surface marking 605, 655 may be integrated within a sheet, which may enhance the visibility of the ridged contrast surface markings. In some aspects, the sheet may comprise a smooth surface that may be contrasted with a ridged contrast surface marking 605, 655. In some implementations, a ridged contrast surface marking 605, 655 may be embedded or attached to the sheet prior to installation, such as during manufacturing. In some embodiments, the sheet and the ridged contrast surface marking 605, 655 may be manufactured together, such as through coextrusion. In some aspects, the shapes of the ridged contrast surface markings 605, 655 may be cut out from the sheet allowing for the insertion of the ridged contrast surface markings 605, 605. In some implementations, the segments may be attached, such as through an adhesive or welding, as non-limiting examples,

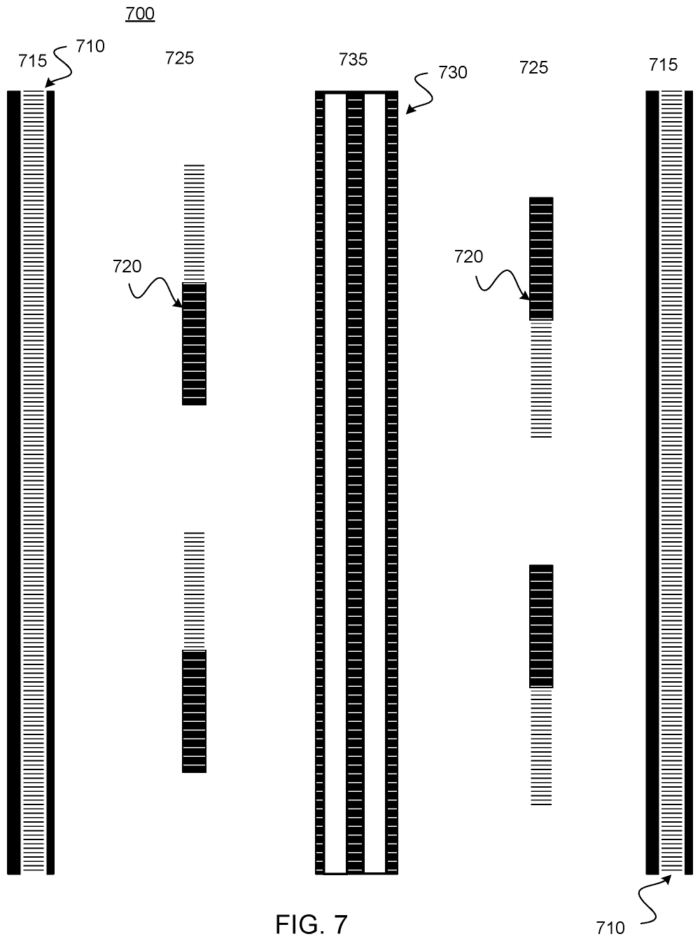

Referring now to FIG. 7, a roadway 700 comprising base surface markings 715, 725, 735 with exemplary ridged contrast surface markings 710, 720, 730 are illustrated. In some embodiments, base surface markings 715, 725m 735 on a roadway 700 may utilize various combinations of ridged contrast surface markings, flat markings, and other profiled or patterned solutions. In some aspects, a portion of contrast surface markings 710 may be located on the message area of the base surface marking 715.

In some embodiments, ridged contrast surface markings 730 may surround messaging of the base surface marking 735 to provide consistent contrast to the message. In some implementations, ridged contrast surface markings 710 may be surrounded by flat color or other profiled solutions. In some aspects, ridged contrast surface markings 720 may comprise both color and profile on leading or lagging edges of the messaging of a base surface marking 725. In some embodiments, the enhancing contrast color on leading or lagging edges of the messaging may enhance the visibility and conspicuity of the messaging for human sight.

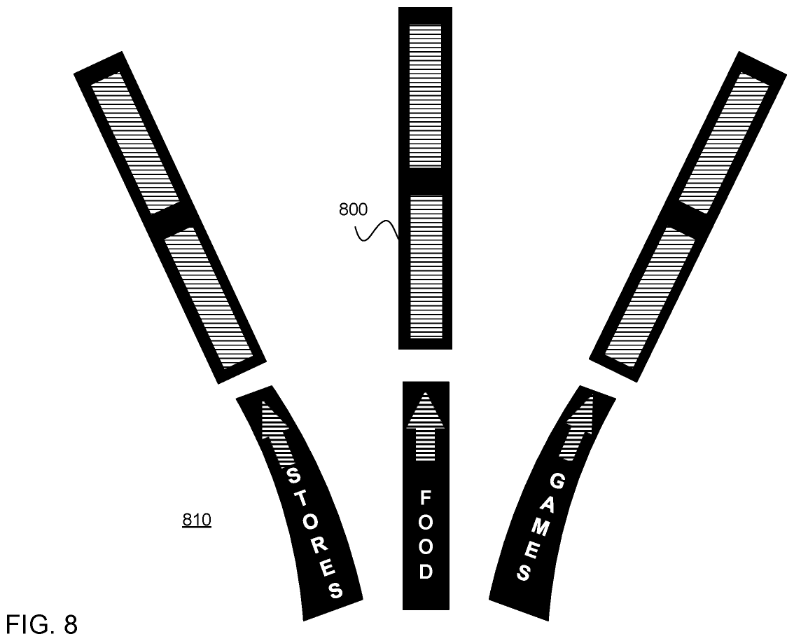

Referring now to FIG. 8, base surface markings 810 with exemplary ridged contrast surface markings 800 are illustrated, wherein the ridged contrast surface markings 800 may provide and enhance messages for mixed pathways for both individuals and CAV. In some embodiments, ridged contrast surface markings 800 may provide additional security or assurances in smart regions where CAV may need to navigate through crowds of people. In some implementations, ridged contrast surface markings 800 may ensure adequate contrast for messages to provide consistent and dependable guidance for CAV. In some aspects, the messages may also be useful for individuals, such as providing directions for the area. In some embodiments, where a ridged contrast surface marking 800 may not run exactly parallel to changing light sources, such as East to West with sunlight, the profile layers of the ridged contrast surface markings may compensate and may be angled and adjusted so the profile layer is consistently perpendicular to the light source.

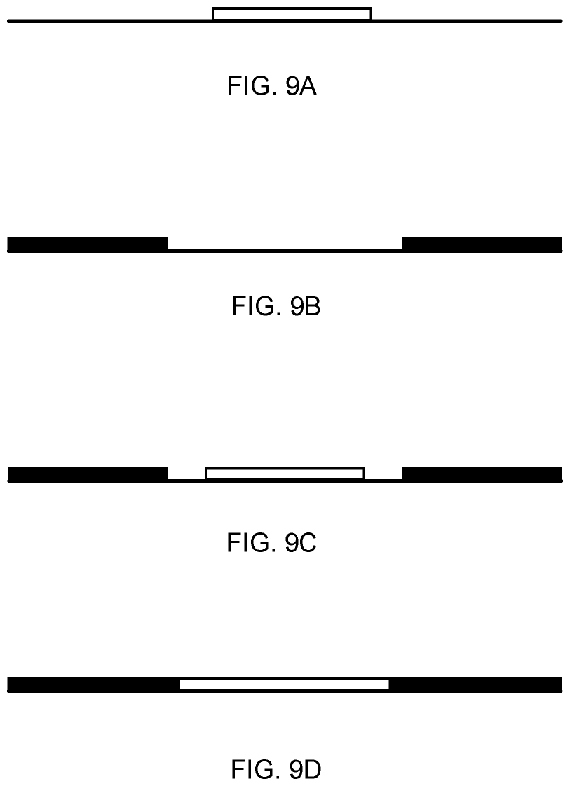

Referring now to FIGS. 9A-9D, cross sections of exemplary ridged contrast surface markings are illustrated, wherein the ridged contrast surface markings are installable on the surface of a base surface. In some aspects, as illustrated in FIG. 9A, the ridged contrast surface marking may be located on the message portion of a base surface marking and may be installed on the base surface, wherein the portion surrounding the message may comprise a contrasting color. In some embodiments, as illustrated in FIG. 9B, the ridged contrast surface marking may provide contrast to a message, wherein the ridged contrast surface marking may be proximate to one or more sides of the message. In some implementations, as illustrated in FIG. 9C, the message and the surrounding contrast color may comprise profiled surfaces, wherein one or more surfaces comprise ridged contrast surface markings. In some aspects, as illustrated in FIG. 9D, the message and the surrounding contrast color may comprise a continuous ridged contrast surface marking with multiple colors.

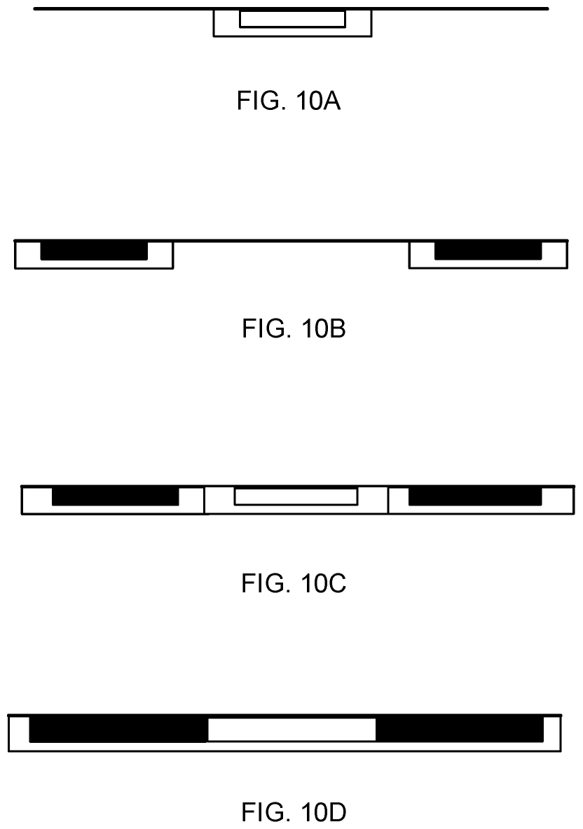

Referring now to FIGS. 10A-10D, cross sections of exemplary ridged contrast surface markings are illustrated, wherein the ridged contrast surface markings are installable into the surface of a base surface. In some implementations, as illustrated in FIG. 10A, the ridged contrast surface marking may be located in the message portion of a base surface marking and may be installed on the base surface, wherein the portion surrounding the message may comprise a contrasting color. In some embodiments, as illustrated in FIG. 10B, the ridged contrast surface marking may provide contrast to a message of a base surface marking.

In some implementations, as illustrated in FIG. 10C, a base surface marking and a ridged contrast surface marking may be installed into or embedded into a base surface, wherein the base surface marking and ridged contrast surface marking may be integrated in separate segments or with separate frames. In some aspects, as illustrated in FIG. 10D, a base surface marking and a ridged contrast surface marking may be installed into or embedded into a base surface, wherein the base surface marking and ridged contrast surface marking may be integrated into a single segment.

In some embodiments, a portion of the layers of the ridged contrast surface marking may be manufactured remotely and installed on site, such as directly onto a base surface. In some implementations, a portion of the layers may be manufactured on site. For example, a portion of the profile layer may be stamped, rolled, or ground directly onto the base surface or directly onto a layer above the base surface, such as an adhesive or conformance layer. In some embodiments, the profile layer may be pressed onto the base surface prior to solidification of the base surface, such as through rolling or stamping. In some aspects, a sealing layer, adhesive layer, or conformance layer may be added to one or more surfaces of the profile layer. In some embodiments, the sealing layer may provide protection and increase durability of the layers most susceptible to the elements. In some implementations, the sealing layer adhesive layer, or conformance layer may be added during installing, during manufacture, or after either. As non-limiting examples, the sealing layer may comprise a resin, sealants, or epoxy.

In some aspects, the sealing layer may be a coating, which may be applied in a variety of methods, such as spraying, rolling, or pouring. In some implementations, the sealing layer may comprise a transparent or semi-transparent material that may be layered over the profile layer. In some embodiments, the sealing layer may overlap with the base surface, which may limit any access or damage to the ridged contrast surface marking. In some implementations, the sealing layer may be poured to create a smooth surface over the profile layer, which may increase the durability of the ridged contrast surface marking.

In some aspects, the different colors of ridged contrast surface markers may comprise different materials. For example, the different materials may be selected based on their ability to maintain their respective color. In some embodiments, ridged contrast surface markers may comprise one or more materials that may be selected to increase longevity and durability of the ridged contrast surface marking. In some implementations, the construction of the profile layer may depend on a range of factors, such as installation preferences, installation constraints, manufacturing preferences, manufacturing constraints, costs, messaging, or base surface types, as non-limiting examples. In some embodiments, a congruous segment may be constructed of one or more materials, which may formed through rolling, stamping, or injection molding, as non-limiting examples.

In some aspects, an adhesive layer may allow for installation of the ridged contrast surface markings into a base surface. For example, the ridged contrast surface markings may be attached through adhesive bonding, thermal bonding, or mechanically fastened, as non-limiting examples. In some embodiments, the method of installation may depend on the base surface, such as a concrete walkway, an asphalt roadway, or interior flooring, as non-limiting examples.

In some embodiments, the layers of the ridged contrast surface marking may be manufactured through one or more manufacturing techniques, such as compression, calendaring, extrusion, injection, transfer, or 3D printing, as non-limiting examples. In some implementations, the method of manufacture may depend on the application, such as the type of base surface, as installing ridged contrast surface markings on top of a cement or concrete pathway in Central Texas may have different requirements than embedded in an asphalt roadway on a coastal highway in California or along a mountainous path in Colorado. For example, the humidity levels would vary drastically between the two locations, which may help inform the best method of installation. As another example, a mountainous path in Colorado may be susceptible to snowfall and would likely need to be ploughed for snow on occasion, which would make the ridged contrast surface marking susceptible to damage from the plough.

In some implementations, the ridged contrast surface marking may be installed to embed within the base surface, which may limit the contact between the ridged contrast surface marking and vehicles traversing the base surface. In some embodiments, embedding the ridged contrast surface marking within the base surface may allow for a smoother drive over the ridged contrast surface marking. In some aspects, the base surface may be poured to include the necessary divots to fit the ridged contrast surface marking. In some embodiments, the divots or recesses may be created during installation of the ridged contrast surface marking.

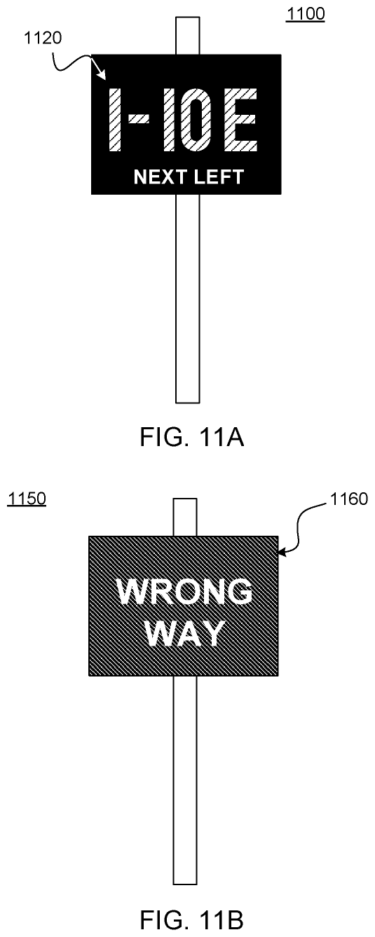

Referring now to FIGS. 11A-11B, exemplary base surface markings 1100, 1150 with ridged contrast surface markings are illustrated, wherein the base surface markings 1100, 1150 comprise vertical signs with messages. In some aspects, extreme light conditions may occur on vertical surfaces, such as with headlights or light reflection from proximate surfaces. In some embodiments, conditions of the sign may create extreme light conditions. In some implementations, a profile of a ridged contrast surface marking 1120, 1160 on a vertical sign may comprise a diagonal profile, which may allow for contrast for a range of light source positions, including vertical and horizontal light rays.

In some embodiments, the ridged contrast surface marking 1120 may line the messaging portion of the base surface marking 1100, wherein the ridged contrast surface marking 1120 provides contrast to the area surrounding the messaging. In some implementations, the ridged contrast surface marking 1160 may surround the messaging of the base surface marking 1150, wherein the ridged contrast surface marking 1160 provides contrast the messaging portion. In some aspects, ridged contrast markings 1120, 1160 may be coated in a material that may enhance visibility and conspicuity of the base surface markings 1100, 1150.

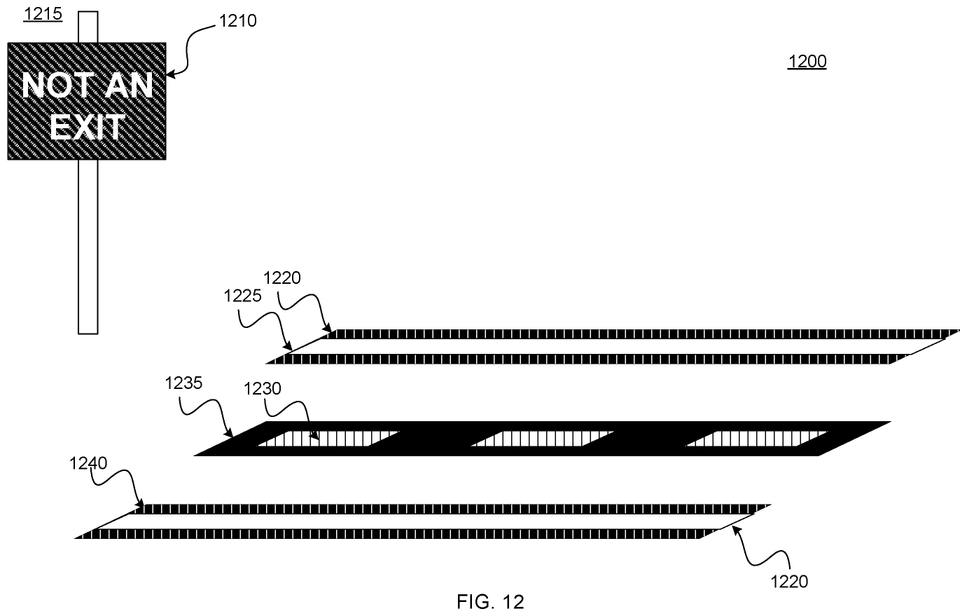

Referring now to FIG. 12, an exemplary street 1200 with roadway ridged contrast surface markings 1220, 1230, 1240 and sign ridged contrast surface marking 1210 are illustrated. In some embodiments, a sign ridged contrast surface marking 1210 may surround the message of the sign base surface marking 1215. In some aspects, roadway ridged contrast surface markings 1220, 1240 may comprise contrasting colors to messages on base surface markings 1225, 1245. In some implementations, roadway ridged contrast surface markings 1230 may comprise contrast to the message of the base surface marking 1235. In some embodiments, at least a portion of the base surface markings 1215, 1225, 1235, 1245 may be applied or provided as tape, paint, colored asphalt, coating, or other color providing material. In some aspects, ridged contrast surface markings 1220, 1230, 1240 may be applied or installed on or into a base surface, and the base surface may be painted or coated with the base surface markings 1225, 1235, 1245 before or after the installation.

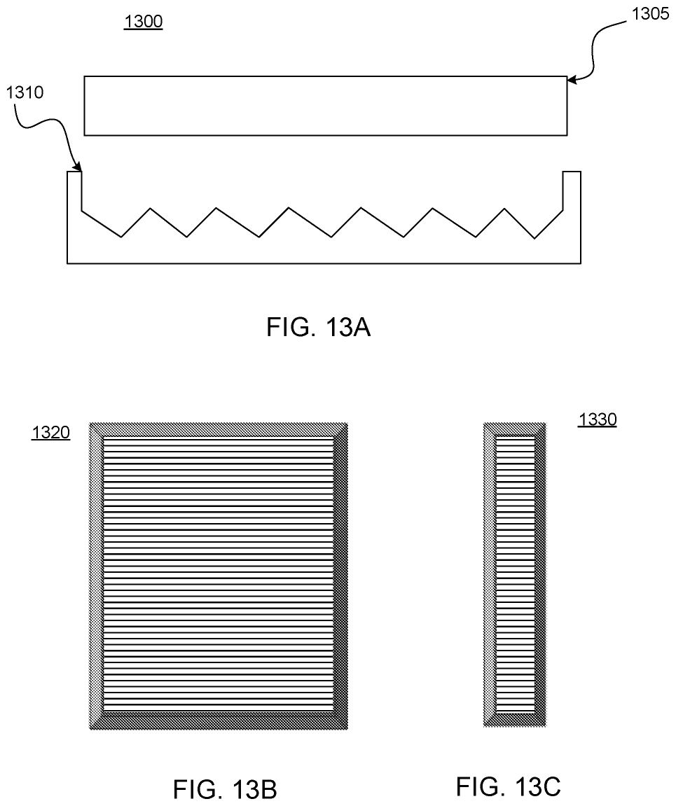

Referring now to FIG. 13A, an exemplary mold system 1300 for manufacturing ridged contrast surface markings 1320, 1330 is illustrated. In some aspects, a mold system 1300 may comprise an upper mold 1305 and a lower mold 1310. In some embodiments, the molding process may comprise pouring in a material between the upper mold 1305 and the lower mold 1310 and then curing the material until hardened. In some implementations, the cured material may be pulled from the mold system 1300 and then finished. In some aspects, finishing may comprise refining the profile layer, wherein refining may result in clean profiles. In some embodiments, the cured material may be attached to other layers, such as illustrated in FIG. 1A. In some aspects, the cured material may be coated.

Referring now to FIG. 13B-13C, exemplary ridged contrast surface markings 1320, 1330 are illustrated, wherein the ridged contrast surface markings 1320, 1330 may be manufactured from a mold system 1300. In some aspects, the ridged contrast surface markings 1320, 1330 may be manufactured utilizing a material that may provide a base color, wherein the base color may the intended color for at least one of the profiles of the ridged contrast surface markings 1320, 1330. In some implementations, the mold system 1300 may be set to manufacture specific sized ridged contrast surface markings 1320, 1330, such as a longitudinal ridged contrast surface marking 1330 or lateral contrast surface marking 1320.

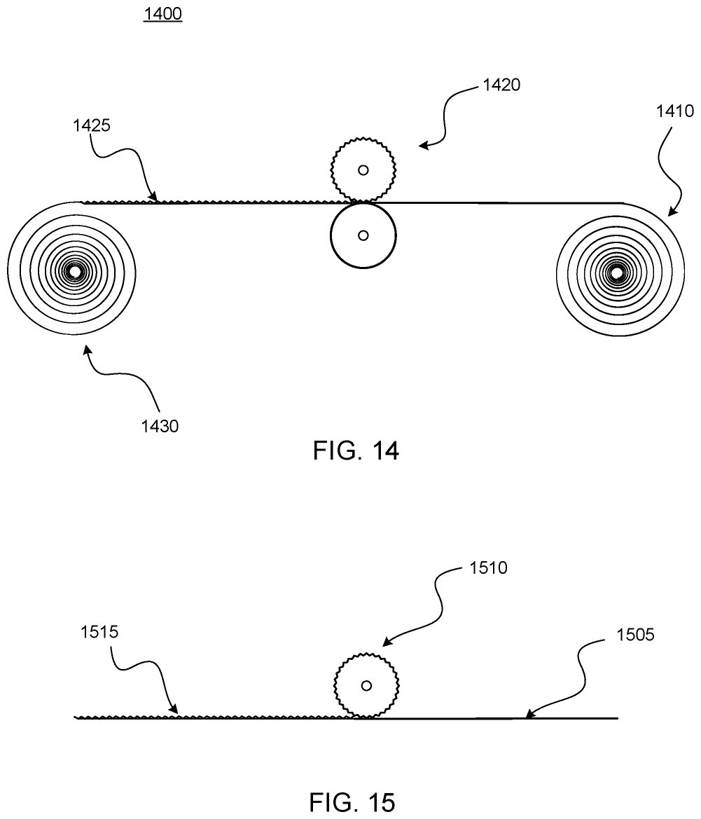

Referring now to FIG. 14, an exemplary calendaring system 1400 is illustrated, wherein the calendaring system 1400 may be used to manufacture ridged contrast surface markings. Typically, calendaring is a manufacturing process of smoothing and compressing a material during production by passing a single continuous sheet 1410 through one or more pairs of heated rolls 1420, wherein the heated rolls 1420 in combination are called calendars. In some aspects, the heated rolls 1420 may be constructed of steel with a hardened surface or steel covered with fiber. In some embodiments, one of the heated rolls 1420 may comprise a profiling surface, wherein when the continuous sheet 1410 passes through the heated rolls 1420, at least one surface 1425 may comprise a profile layer. In some implementations, a processed sheet 1430 may be rolled, which may allow for customized sizing for installation.

Referring now to FIG. 15, an exemplary roller 1510 is illustrated, wherein the roller 1510 may be used directly on a base surface 1505 to create ridged contrast surface markings. In some aspects, a roller 1510 may be attached to a vehicle that may drive over the base surface 1505, wherein the roller 1510 may add one or more profiles to the base surface 1505. In some implementations, the base surface 1505 may be wet or only partially set, which may allow the roller 1510 to effectively imprint the base surface 1505 with a profile layer 1515. In some embodiments, the color may be integrated into the material, such as during manufacturing.

### CONCLUSION

A number of embodiments of the present disclosure have been described. While this specification contains many specific implementation details, these should not be construed as limitations on the scope of any disclosures or of what may be claimed, but rather as descriptions of features specific to particular embodiments of the present disclosure.

Certain features that are described in this specification in the context of separate embodiments can also be implemented in combinations or in a single embodiment. Conversely, various features that are described in the context of a single embodiment can also be implemented in combination in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order show, or sequential order, to achieve desirable results. In certain implementations, multitasking and parallel processing may be advantageous. Nevertheless, it will be understood that various modifications may be made without departing from the spirit and scope of the claimed disclosure.

What is claimed is:

1. A ridged contrast surface marking comprising:
a profile layer comprising an angular profile installable parallel to a base surface and proximate to a base surface marking with messaging,
wherein the angular profile comprises a topography of angles that reflect light out of a direction of a person or object traversing the base surface, that absorb light and limit reflection of light into the direction of the person or object, or both, and
wherein the proximity of the profile layer to the base surface marking allows for increased or maintained visibility and conspicuity of the messaging when traversing the base surface in extreme light conditions.

2. The ridged contrast surface marking of claim 1, wherein the profile layer comprises one or both a reflective material or reflective coating that increase visibility of the base surface marking.

3. The ridged contrast surface marking of claim 1, wherein the profile layer comprises one or both a light absorbing material or light absorbing coating increasing visibility and conspicuity of the base surface marking.

4. The ridged contrast surface marking of claim 1, wherein the angular profile is configured to increase visibility and conspicuity of the messaging for one or both autonomous vehicles and vehicles with automated driver assistance systems traversing the base surface.

5. The ridged contrast surface marking of claim 1, wherein the angular profile comprises a symmetrical profile.

6. The ridged contrast surface marking of claim 1, wherein the angular profile comprises an asymmetrical profile.

7. The ridged contrast surface marking of claim 1, further comprising a conformance layer installable parallel to the base surface and below the profile layer, wherein the conformance layer conforms the ridged contrast surface marking to regulatory standards.

8. The ridged contrast surface marking of claim 1, wherein the profile layer is imprinted onto the base surface.

9. The ridged contrast surface marking of claim 1, wherein the ridged contrast surface marking is installed through adhesion.

10. The ridged contrast surface marking of claim 9, further comprising an adhesive layer located under the profile layer, wherein the adhesive layer attaches the ridged contrast surface marking to the base surface.

11. A ridged contrast surface marking comprising:
a base surface traversable by one or more person or object;
a base surface marking on the base surface, wherein the base surface marking provides messaging; and
a profile layer comprising an angular profile installable parallel to a base surface and proximate to a base surface marking with messaging,
wherein the angular profile comprises a topography of angles that reflect light out of a direction of a person or object traversing the base surface, that absorb light and limit reflection of light into the direction of the person or object, or both, and
wherein the proximity of the profile layer to the base surface marking allows for increased or maintained visibility and conspicuity of the messaging when traversing the base surface in extreme light conditions.

12. The ridged contrast surface marking of claim 11, wherein the profile layer comprises one or both a reflective material or reflective coating that increase visibility of the base surface marking.

13. The ridged contrast surface marking of claim 11, wherein the profile layer comprises one or both a light absorbing material or light absorbing coating increasing visibility and conspicuity of the base surface marking.

14. The ridged contrast surface marking of claim 11, wherein the angular profile comprises a symmetrical profile.

15. The ridged contrast surface marking of claim 11, wherein the angular profile comprises an asymmetrical profile.

16. The ridged contrast surface marking of claim 11, wherein the angular profile is configured to increase visibility and conspicuity of the messaging for one or both autonomous vehicles and vehicles with automated driver assistance systems traversing the base surface.

17. The ridged contrast surface marking of claim 11, further comprising:
a conformance layer installable parallel to the base surface and below the profile layer, wherein the conformance layer conforms the ridged contrast surface marking to regulatory standards.

18. The ridged contrast surface marking of claim 11, wherein the angular profile is pressed onto the base surface prior to solidification of the base surface.

19. The ridged contrast surface marking of claim 11, wherein the ridged contrast surface marking is installed through adhesion.

20. The ridged contrast surface marking of claim 19, further comprising an adhesive layer located under the profile layer, wherein the adhesive layer attaches the ridged contrast surface marking to the base surface.
